(19) United States
(12) Patent Application Publication
(10) Pub. No.: US 2021/0015239 A1
(43) Pub. Date: Jan. 21, 2021

(54) AIRLESS EYE CREAM CONTAINER

(71) Applicant: SAMHWA PLASTIC IND.CO., Uiwang-si Gyeonggi-do (KR)

(72) Inventors: Ki Sung LEE, Suwon-si Gyeonggi-do (KR); Jun Young KIM, Suwon-si Gyeonggi-do (KR)

(21) Appl. No.: 17/040,205

(22) PCT Filed: Oct. 19, 2018
(86) PCT No.: PCT/KR2018/012419

§ 371 Date: Sep. 22, 2020

(30) Foreign Application Priority Data
Mar. 23, 2018 (KR) 10-2018-0034030

(51) Int. Cl. A45D 40/26

(52) U.S. Cl. CPC A45D 40/261; A45D 2200/051

(57) ABSTRACT

An airless eye cream container is proposed. The container includes an airless pump installed to be very suitably used for an eye cream cosmetic container so as to store eye cream cosmetics exclusively to block the introduction of external air or foreign substances and prevent contamination and deterioration of cosmetics, and a predetermined amount of eye cream can be accurately discharged and used by operating the pump in use to not only improve the convenience of use, but also reduce the waste of cosmetics.

### TECHNICAL FIELD

The present invention relates to an airless eye cream container, and more particularly, to an airless eye cream container in which an airless pump is installed to be very suitably used for an eye cream cosmetic container so as to store eye cream cosmetics exclusively to block the introduction of external air or foreign substances and prevent contamination and deterioration of cosmetics, and a predetermined amount of eye cream is accurately discharged and used by operating the pump in use to not only improve the convenience of use, but also reduce the waste of cosmetics.

### BACKGROUND ART

In general, skin functions are deteriorated by large and small spots, freckles, blemishes, stains, and age spots on a person's face as well as excessive dryness or large and small wrinkles occurring due to internal and external factors of the body with age. In particular, many people have dark circles around both eyes.

In order to prevent various conditions occurring in the skin of people's faces in advance, or to cover or remove the conditions which have already occurred, various medical procedures have been performed or various functional cosmetics have been widely used.

Among them, functional cosmetics for covering dark circles around the eyes so as not to be seen visually are called eye cream cosmetics, and these eye cream cosmetics have also been proposed to add various functions that expect effects such as moisturizing, whitening, removing wrinkles, and removing impurities from the stratum corneum around the eyes, in addition to a function of caring and covering dark circles.

In addition, the functional cosmetics have been widely used to have effects such as moisturizing, whitening, removing wrinkles, and removing impurities from the stratum corneum on the entire face as well as a specific area such as around the eyes.

The eye cream cosmetics as described above are generally applied by hands or using various types of makeup tools, but in this case, there is a problem in that unsanitary problems occur and it is not easy to apply cosmetics efficiently to specific areas.

In addition, since a conventional eye cream cosmetic container is simply opened and closed with a lid, external air or foreign substances are introduced through a nozzle even when the cosmetics are used or not used, and thus, there was a problem in that the cosmetics are easily contaminated and deteriorated. Even if the cosmetics are not contaminated and deteriorated, there is a serious problem in that the original ingredients of the cosmetics are lost by easily removing moisture as well as the unique fragrance and odor of the cosmetics.

In addition to the above problems, when the cosmetics are used, it is difficult to accurately discharge and use the cosmetics in the cosmetic container by an appropriate amount to be required, that is, the cosmetics need to be discharged and used by the user's sense, and thus, there was a problem in that the waste of cosmetics was caused.

Accordingly, in consideration of the conventional structural problems as described above, a configuration is proposed in which a separate tip is formed on the nozzle part from which the cosmetic is finally discharged so that the user may apply the cosmetics directly to the skin using the tip instead of by hands.

However, this configuration has an advantage that the user may not use the hands by forming the tip on the nozzle part, but there are still conventional structural problems that external air or foreign substances may be introduced through the nozzle and the discharge amount of the cosmetics cannot be accurately determined.

### DISCLOSURE

### Technical Problem

The present invention is invented to meet the needs of the related art described above, and an object of the present invention is to provide an airless eye cream container, in which an airless pump is installed to be very suitably used for an eye cream cosmetic container so as to store eye cream cosmetics exclusively to block the introduction of external air or foreign substances and prevent contamination and deterioration of cosmetics, and a predetermined amount of eye cream is accurately discharged and used by operating the pump in use to not only improve the convenience of use, but also to reduce the waste of cosmetics.

### Technical Solution

According to a first embodiment of the present invention, there is provided an airless eye cream container comprising: a cylindrical container (10) having an open upper portion and a closed lower portion, in which a lower valve (11) for pumping up an eye cream cosmetic is inserted into the lower portion; a valve housing (20) which is a cylindrical member having open upper and lower portions to be coupled to an upper opening of the cylindrical container (10); cylindrical upper and lower valve discs (30, 40) which are respectively coupled to the inner peripheries of the upper and lower openings of the valve housing (20) and have an open upper portion and an inlet (31) and an outlet (41) for suction and discharge of the eye cream cosmetic formed at the center of the lower portion thereof; suction and discharge valves (50, 60) which are inserted into the inner peripheries of the upper and lower valve discs (30, 40), respectively; a disc-shaped guide member (70) installed at an upper portion of the lower valve disc (40) and having a hole (71) formed at the center thereof; a push button (80) made of a flexible material fitted to one side of the valve housing (20); a grip member (90) rotatably gripping a ball (91) at the inner circumferential edge thereof, the grip member being a cylindrical member fixed to the outer circumferential edge of an upper end of the valve housing (20) while fixing an upper outer circumferential edge of the push button (80); and a cover member (100) covering the valve housing (20) and the grip member (90) from the outer circumferential edge.

The airless eye cream container may further comprise a plate spring (110) which is installed in an inner space (A) of the push button (80) to return to the original state after pressing the push button (80).

### Advantageous Effects

According to the airless eye cream container of the present invention, an airless pump is installed in the eye cream container to promote convenience in use, and to fundamentally block the introduction of external air and foreign substances and at the same time to block the fragrance or moisture of cosmetics from being emitted from the inside, thereby preventing contaminants and deterioration of cosmetics and preventing functional degradation.

### DESCRIPTION OF DRAWINGS

FIG. 1 is an exploded perspective view illustrating an airless eye cream container of the present invention,

FIG. 2 is a cross-sectional view illustrating the airless eye cream container of the present invention,

FIG. 3 is a cross-sectional view illustrating when a button of the airless eye cream container of the present invention is pressed,

FIG. 4 is a cross-sectional view illustrating when the button of the airless eye cream container of the present invention is released, and

FIG. 5 is a cross-sectional view illustrating an airless eye cream container applied with a nozzle-type applicator of the present invention.

### BEST MODE

According to a first embodiment of the present invention, there is provided an airless eye cream container comprising: a cylindrical container 10 having an open upper portion and a closed lower portion, in which a lower valve 11 for pumping up an eye cream cosmetic is inserted into the lower portion; a valve housing 20 which is a cylindrical member having open upper and lower portions to be coupled to an upper opening of the cylindrical container 10; cylindrical upper and lower valve discs 30 and 40 which are respectively coupled to the inner peripheries of the upper and lower openings of the valve housing 20 and have an open upper portion and an inlet 31 and an outlet 41 for suction and discharge of the eye cream cosmetic formed at the center of the lower portion thereof; suction and discharge valves 50 and 60 which are inserted into the inner peripheries of the upper and lower valve discs 30 and 40, respectively; a disc-shaped guide member 70 installed at an upper portion of the lower valve disc 40 and having a hole 71 formed at the center thereof; a push button 80 made of a flexible material fitted to one side of the valve housing 20; a grip member 90 rotatably gripping a ball 91 at the inner circumferential edge thereof, the grip member being a cylindrical member fixed to the outer circumferential edge of an upper end of the valve housing 20 while fixing an upper outer circumferential edge of the push button 80; and a cover member 100 covering the valve housing 20 and the grip member 90 from the outer circumferential edge.

Hereinafter, a preferred embodiment of the present invention will be described with reference to the accompanying drawings so as to be easily implemented by those skilled in the art. In the accompanying drawings, it should be noted that like reference numerals are used as far as possible when the reference numerals indicated in the configurations indicate like configurations even in different drawings. In the following description of the present invention, a detailed description of known related functions and configurations will be omitted when it is determined when the detailed description may unnecessarily make the gist of the present invention unclear. In addition, some features presented in the drawings are enlarged or reduced or simplified for ease of description, and the drawings and components thereof are not necessarily illustrated at appropriate ratios. However, those skilled in the art will easily understand these details.

Terms including ordinal numbers, such as ‘first’ and ‘second’, may be used for describing various components, but the components are not limited by the terms. The terms are used only for discriminating one component from the other component. For example, without departing from the scope of the present invention, a first component may be referred to as a second component, and similarly, the second component may be referred to as the first component. A term ‘and/or’ includes a combination of a plurality of associated items to be disclosed or any item of the plurality of associated items to be disclosed.

In addition, relative terms described based on those shown in the drawings, such as ‘front’, ‘rear’, ‘upper’, and ‘lower’, will be replaced with ordinals such as ‘first’ and ‘second’.

For ordinal numbers such as ‘first’ and ‘second’, the order thereof is an order to be mentioned above or arbitrarily defined, and the order thereof may be arbitrarily changed as necessary.

Terms used in the present invention are used only to describe specific embodiments, and are not intended to limit the present invention. A singular form may include a plural form unless otherwise clearly indicated in the context. In the present application, it should be understood that the term “comprising” or “having” indicates that a feature, a number, a step, an operation, a component, a part or a combination thereof described in the specification is present, but does not exclude a possibility of presence or addition of one or more other features, numbers, steps, operations, components, parts or combinations thereof, in advance.

Unless defined otherwise, all terms to be used herein including technological or scientific terms have the same meaning as those generally understood by a person with ordinary skill in the art. It should be understood that terms defined in advance, which are generally used, have the same meanings as contextual meanings of associated techniques and unless apparently defined in this application, the terms are not ideally or excessively analyzed as formal meanings.

Hereinafter, preferred embodiments of the present invention will be described in detail with reference to the accompanying drawings. Further, in describing the present invention, a detailed description for known related configurations or functions will be omitted when it is determined that the detailed description may obscure the gist of the present invention.

### Embodiments

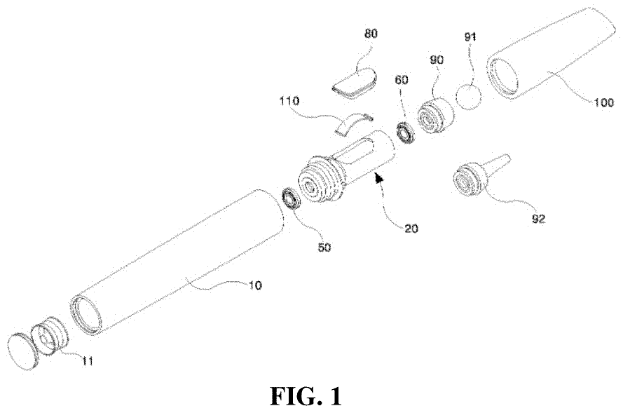

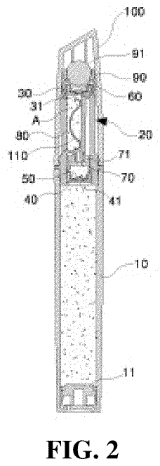

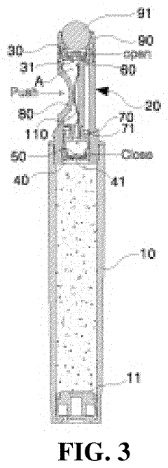

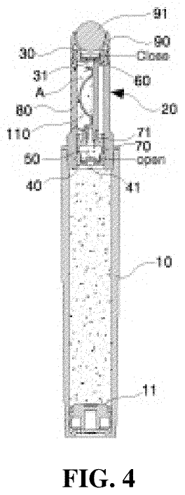

FIG. 1 is an exploded perspective view illustrating an airless eye cream container of the present invention, FIG. 2 is a cross-sectional view illustrating the airless eye cream container of the present invention, FIG. 3 is a cross-sectional view illustrating when a button of the airless eye cream container of the present invention is pressed, and FIG. 4 is a cross-sectional view illustrating when the button of the airless eye cream container of the present invention is released.

As illustrated in FIGS. 1 to 4, an airless eye cream container of the present invention comprises: a cylindrical container 10 having an open upper portion and a closed lower portion, in which a lower valve 11 for pumping up an eye cream cosmetic is inserted into the lower portion; a valve housing 20 which is a cylindrical member having open upper and lower portions to be coupled to an upper opening of the cylindrical container 10; cylindrical upper and lower valve discs 30 and 40 which are respectively coupled to the inner peripheries of the upper and lower openings of the valve housing 20 and have an open upper portion and an inlet 31 and an outlet 41 for suction and discharge of the eye cream cosmetic formed at the center of the lower portion thereof; suction and discharge valves 50 and 60 which are inserted into the inner peripheries of the upper and lower valve discs 30 and 40, respectively; a disc-shaped guide member 70 installed at an upper portion of the lower valve disc 40 and having a hole 71 formed at the center thereof; a push button 80 made of a flexible material fitted to one side of the valve housing 20; a grip member 90 rotatably gripping a ball 91 at the inner circumferential edge thereof, the grip member being a cylindrical member fixed to the outer circumferential edge of an upper end of the valve housing 20 while fixing an upper outer circumferential edge of the push button 80; and a cover member 100 covering the valve housing 20 and the grip member 90 from the outer circumferential edge.

The airless eye cream container may further comprise a plate spring 110 which is installed in an inner space A of the push button 80 to return to the original state after pressing the push button 80.

As described above, the operations and effects of the airless eye cream container of the present invention configured as described above will be described.

First, in order to use the eye cream container, the cover member 100 is opened, and when the push button 80 is pressed, a volume of the inner space A of the valve housing 20 is reduced, and the discharge valve 60 at the top is opened by the pressure. The eye cream cosmetics are discharged through the discharge valve 60 opened as described above, so that the eye cream cosmetics are applied on the ball 91 at the lower portion of the grip member 90 (FIG. 3).

As such, when the ball 91 is rotated while the ball 91 is in contact with the face, that is, the lower portion of the eye, makeup is performed while massaging with the eye cream cosmetics applied around the ball 91.

When the makeup is finished and the pressing operation of the push button 80 is released, while the flexible push button 80 returns to its original state, the volume of the inner space A of the valve housing 20 increases, the suction valve 50 at the lower portion is opened, and the eye cream cosmetics in the cylindrical container 10 are introduced through the inlet 31 to be filled in the inner space A (FIG. 4).

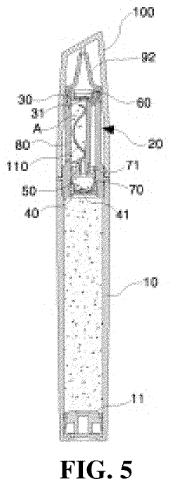

FIG. 5 is a cross-sectional view illustrating an airless eye cream container applied with a nozzle-type applicator of the present invention.

Instead of the grip member 90 and the ball 91, a nozzle-type applicator 92 is mounted to apply the eye cream cosmetics.

As described above, when the pressing operation of the push button 80 is released, the upper discharge valve 60 is closed to prevent external air from being introduced into the cylindrical container 10, thereby preventing deterioration of the eye cream cosmetics. Since only the eye cream cosmetics filled in the inner space A are discharged and used, only a predetermined amount may be used without waste.

As described above, the detailed embodiments have been described in the detailed description of the present invention, but it will be apparent that there is a possibility that the technology of the present invention will be easily modified and implemented by those skilled in the art and these modified embodiments will be included in the technical spirit disclosed in the appended claims of the present invention.

### INDUSTRIAL APPLICABILITY

According to the airless eye cream container of the present invention, an airless pump is installed in the eye cream container to promote convenience in use, and to fundamentally block the introduction of external air and foreign substances and at the same time to block the fragrance or moisture of cosmetics from being emitted from the inside, thereby preventing contaminants and deterioration of cosmetics and preventing functional degradation.

1. An airless eye cream container comprising:
a cylindrical container (10) having an open upper portion and a closed lower portion, in which a lower valve (11) for pumping up an eye cream cosmetic is inserted into the lower portion;
a valve housing (20) which is a cylindrical member having open upper and lower portions to be coupled to an upper opening of the cylindrical container (10);
cylindrical upper and lower valve discs (30, 40) which are respectively coupled to the inner peripheries of the upper and lower openings of the valve housing (20) and have an open upper portion and an inlet (31) and an outlet (41) for suction and discharge of the eye cream cosmetic formed at the center of the lower portion thereof;
suction and discharge valves (50, 60) which are inserted into the inner peripheries of the upper and lower valve discs (30, 40), respectively;
a disc-shaped guide member (70) installed at an upper portion of the lower valve disc (40) and having a hole (71) formed at the center thereof;
a push button (80) made of a flexible material fitted to one side of the valve housing (20);
a grip member (90) rotatably gripping a ball (91) at the inner circumferential edge thereof, the grip member being a cylindrical member fixed to the outer circumferential edge of an upper end of the valve housing (20) while fixing an upper outer circumferential edge of the push button (80); and
a cover member (100) covering the valve housing (20) and the grip member (90) from the outer circumferential edge.

2. The airless eye cream container of claim 1, further comprising:
a plate spring (110) which is installed in an inner space (A) of the push button (80) to return to the original state after pressing the push button (80).
